(19) United States
(12) Patent Application Publication
(10) Pub. No.: US 2014/0300118 A1
(43) Pub. Date: Oct. 9, 2014

(54) DOOR SYSTEM FOR MACHINE

(71) Applicant: Caterpillar Inc., Peoria, IL (US)

(72) Inventors: Matthew J. Gielda, Peria, IL (US); Jeffrey A. Zurinski, Oglesby, IL (US)

(21) Appl. No.: 14/312,864

(22) Filed: Jun. 24, 2014

(51) Int. Cl. E05C 19/02

(52) U.S. Cl. CPC E05C 19/02
USPC 292/340

(57) ABSTRACT

A door system for a machine is provided. The door system includes a door movable between a closed position and a hold-open position. The door system includes a first latching member and a second latching member with respective first and second release members. The door system further includes a striker having a first interlocking element and a second interlocking element. The striker is configured to selectively couple with the first latching member and the second latching member. The striker is coupled with both the first latching member and the second latching member to retain the door in the hold-open position.

### TECHNICAL FIELD

The present disclosure relates to a door system of an operator station for a machine.

### BACKGROUND

Machines for performing operations like earthmoving, lifting, dumping, transportation and the like typically include a cab or an operator cabin. The cab may include one or more doors that, when closed, isolate an interior of the cab against the surrounding environment. However, in certain instances it may be desirable for the operator to be able to maintain the door in an open position when operating the equipment. Thus, these machines include a latching mechanism for retaining the door in a hold-open position. However, the latching mechanism may include multiple release systems that may be provided at different locations on the machine. Some of the locations may be inconvenient for an operator to access.

U.S. Pat. No. 5,655,798 (the '798 patent) discloses a door hold-open latch and dual release mechanism. The mechanism includes a first latch for maintaining the door in its closed position and a second latch for maintaining the door in its open position. A first latch release is mounted on the door in a position accessible to an operator located in the cab for releasing the first latch. A second latch release is mounted on the door in a position accessible to an operator located in the cab for releasing the second latch. A third latch release is mounted on the door in a position accessible to an operator located on the ground for also releasing the second latch. The operator can actuate the second latch from either the cab using the second latch release or from ground level using the third latch release. Alternately, the third latch release can also release the first latch, and the operator can actuate the first latch using the third latch release.

The latching mechanism as described in the '798 patent provides the second and third latch releases that allows the operator to release the door from the hold-open position from the cab level and the ground level, respectively. However, the operator may not be able to conveniently release the door from the hold-open position when located outside the cab at the cab level. Further, providing another latch release outside the cab at the cab level may require running cables and/or linkages through and/or along the door. This may result in a complicated structure of the latch mechanism.

### SUMMARY OF THE DISCLOSURE

In one aspect of the present disclosure, a door system for a machine is provided. The door system includes a door movable between a closed position and a hold-open position. The door system includes a first latching member coupled to the door. The first latching member includes a first support portion. The door system includes a first release member coupled to the door. The first release member is operably connected to the first latching member. Further, the first release member is actuable from outside an operator enclosure of the machine. The door system also includes a second latching member coupled to the operator enclosure of the machine. The second latching member includes a second support portion. The door system includes a second release member coupled to the operator enclosure. The second release member is operably connected to the second latching member. Further, the second release member is actuable from inside the operator enclosure. The door system further includes a striker. The striker includes a first interlocking element configured to selectively couple with the first latching member, and a second interlocking element configured to selectively couple with the second latching member. Further, the striker is configured to couple with the first latching member and the second latching member to retain the door in the hold-open position. Furthermore, in response to actuation of the first release member, the striker is disengaged from the first latching member such that the door is movable from the hold-open position and the striker remains coupled with the second latching member. Furthermore, in response to actuation of the second release member, the striker is disengaged from the second latching member such that the door is movable from the hold-open position and the striker remains coupled with the first latching member. The first support portion is configured to retain the shuttle adjacent to the first latching member when the shuttle is disengaged from the second latching member. The second support portion is configured to retain the shuttle adjacent to the second latching member when the shuttle is disengaged from the first latching member.

Other features and aspects of this disclosure will be apparent from the following description and the accompanying drawings.

### BRIEF DESCRIPTION OF THE DRAWINGS

FIG. 1 is a perspective view of a door system of an operator station of a machine with a door in a hold-open position, according to an embodiment of the present disclosure;

FIG. 2 illustrates an orthogonal view of a latching system associated with the door system of FIG. 1, according to an embodiment of the present disclosure;

FIG. 3 illustrates an orthogonal view of the latching system of FIG. 2 in a first operational state;

FIG. 4 illustrates an orthogonal view of the latching system of FIG. 2 in a second operational state; and

FIG. 5 illustrates an orthogonal view of the latching system, according to another embodiment of the present disclosure.

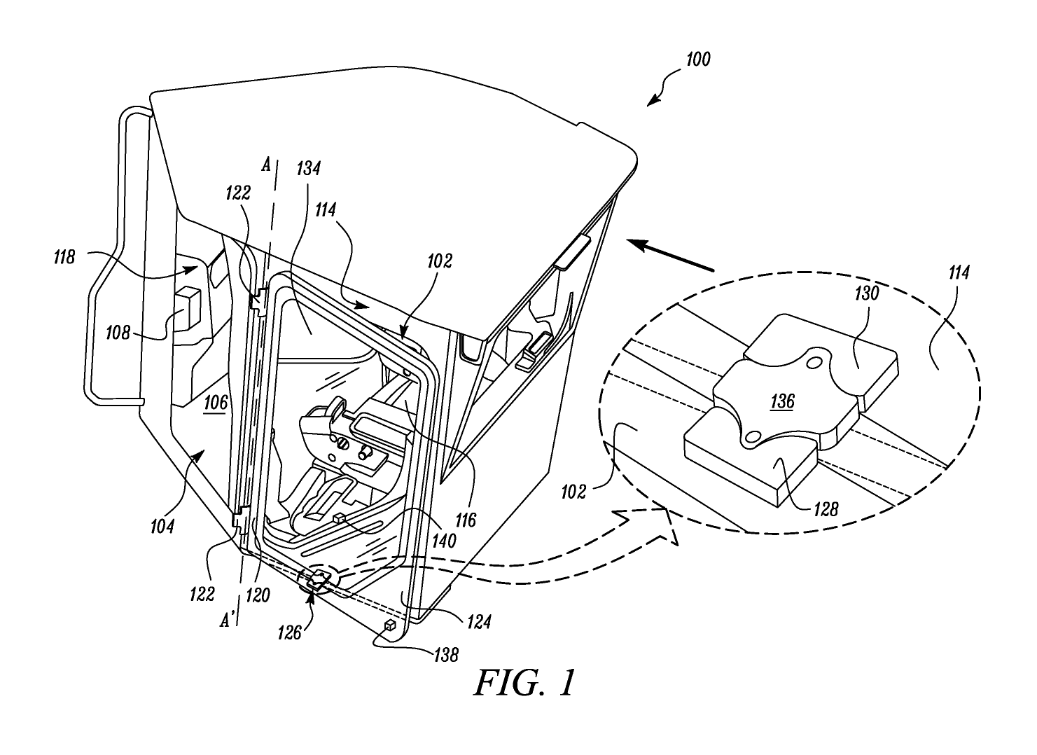

### DETAILED DESCRIPTION

Wherever possible, the same reference numbers will be used throughout the drawings to refer to the same or the like parts. FIG. 1 illustrates a perspective view of an exemplary door system 100 for a machine (not shown), according to an embodiment of the present disclosure. The machine may be a backhoe loader, a track type tractor, a compactor, an excavator, a skid steer loader, or any other agricultural, mining or construction machinery. The door system 100 includes a door 102 configured to cover an opening 104 of an operator enclosure 106 of the machine. The door 102 is movable between a closed position and a hold-open position. In the closed position (not shown), the door 102 covers the opening 104 of the operator enclosure 106. In the hold-open position, as illustrated in FIG. 1, the opening 104 may be accessible by an operator of the machine. The door system 100 includes a door latching mechanism 108. The door latching mechanism 108 is configured to retain the door 102 in the closed position. A release actuator (not shown) enables the operator to release the latching mechanism 108 so that the door 102 may be pivoted open, and the operator may enter and exit the operator enclosure 106.

The operator enclosure 106 includes a frame 114 that may house one or more operator seats 116 and a dashboard 118. The dashboard 118 may include one or more controls and/or operator display devices (not shown) for operating and/or monitoring various components of the machine.

The door 102 includes a first end 120, a hinge portion 122 and a second end 124. The first end 120 is rotatably connected to the to the hinge portion 122 about a swing axis A-A′. The hinge portion 122 is integrally attached to the frame 114 of the operator enclosure 106. The second end 124 is configured to rotate about the swing axis A-A′ such that the door 102 is movable between the closed position and the hold-open position (shown in FIG. 1).

The door system 100 includes a latching system 126. The latching system 126 includes a first latching member 128 coupled to the door 102, and a second latching member 130 coupled to the frame 114 of the operator enclosure 106 of the machine. The latching system 126 further includes a striker 136. The striker 136 is coupled with both the first latching member 128 and the second latching member 130 to retain the door 102 in the hold-open position.

In the illustrated embodiment, the first latching member 128 is coupled to a bottom portion of the door 102, and the second latching member 130 is coupled at a corresponding location on the frame 114. However, it is to be noted that the latching system 126 may be located at any appropriate location to achieve the objective of the present disclosure and to correspond with the chosen structure of the door 102 and the operator enclosure 106. For example, in the illustrated embodiment, the door 102 includes a single glass portion 134 and thus the latching system 126 is disposed on a frame of the door 102. However, in an alternative embodiment (not shown), the door structure may include an upper glass portion and a lower glass portion instead of a single glass portion 134 shown in FIG. 1. The upper glass and the lower glass portions may be supported by a housing having a horizontal central pillar to support the upper and the lower glass portions. The latching system 126 in this embodiment may then be mounted on the horizontal central pillar.

The door system 100 further includes a first release member 138 coupled to the door 102 and operably connected to the first latching member 128. The first release member 138 is actuable from outside the operator enclosure 106. The door system 100 further includes a second release member 140 coupled to the frame 114 of the operator enclosure 106 and operably connected to the second latching member 130. The second release member 140 is actuable from inside the operator enclosure 106. The terms “outside” and “inside”, as used herein, are with reference to the operator enclosure 106. The first release member 138 may be accessible to an operator located outside the operator enclosure 106. Similarly, the second release member 140 may be accessible to an operator located inside the operator enclosure 106.

The first release member 138 and the second release member 140 may be in the form of push button switches, cable pull switches, or door release levers. The first release member and second release members 138, 140 may actuate the first and second latching members 128, 130 via mechanical or cable linkages, electrical signals, pneumatic actuation, hydraulic actuation, or a combination thereof. In an embodiment, the second release member 140 may be mounted on the dashboard 118 of the operator enclosure 106. A person having ordinary skill in the art may acknowledge that the location of the first release member 138 may be anywhere on the door 102 and the location of the second release members 140 may be anywhere within the operator enclosure 106 such that the first and the second release members 138, 140 may be appropriately placed within the reach of the operator. The various components of the latching system 126, as shown in

FIG. 1, are exemplary in nature and the components may be of any alternative structure or configuration in various other implementations of the present disclosure.

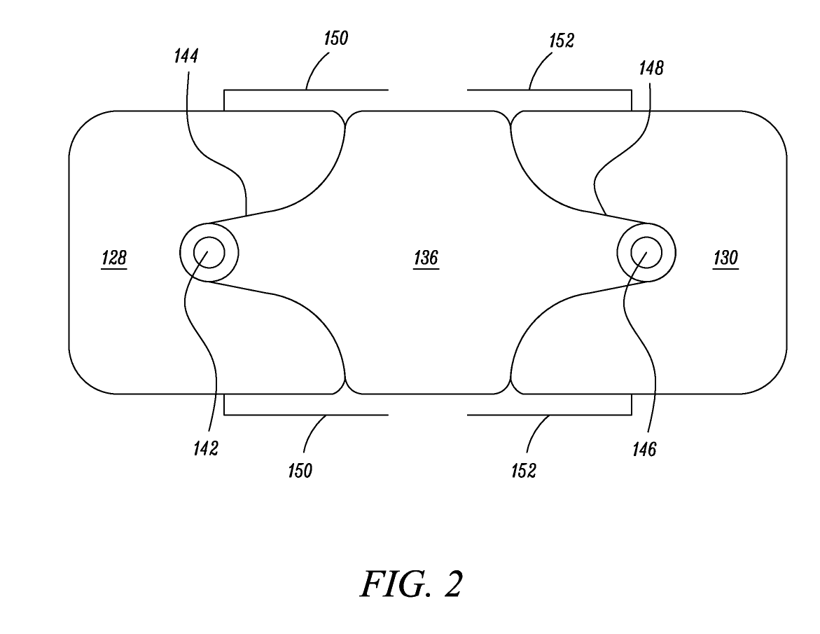

FIG. 2 illustrates an orthogonal view of the latching system 126, according to an embodiment of the present disclosure. The striker 136 includes a first interlocking element 142 configured to selectively couple with a complementary locking element 144 of the first latching member 128. The striker 136 further includes a second interlocking element 146 configured to selectively couple with a complementary locking element 148 of the second latching member 130. The striker 136 is coupled with both the first latching member 128 and the second latching member 130 to retain the door 102 in the hold-open position. The first and second interlocking elements 142, 146 and the complementary locking elements 144, 148, as shown FIG. 2, are for illustrative purposes only, and many alternative structures and/or configurations are possible within the scope of the present disclosure.

The first latching member 128 includes a first support portion 150. In an embodiment, the first support portion 150 may be a pair of parallel plates coupled to each side of the first latching member 128. The second latching member 130 includes a second support portion 152. In an embodiment, the second support portion 152 may be a pair of parallel plates coupled to each side of the second latching member 130. The first and second support portions 150, 152 may be made of metal or metallic alloys, plastics, composites, and the like. In an alternative embodiment, each of the first and the second support portions 150, 152 may be a cylindrical body coupled to the first and the second latching member 128, 130 respectively. Further, a length of the first support portion 150 and the second support portion 152 may be such that when the door 102 is in the hold-open position, the support portions 150, 152 do not overlap each other. Moreover, the first and second support portions 150, 152 may be made of metal or metallic alloys, plastics, composites, and the like

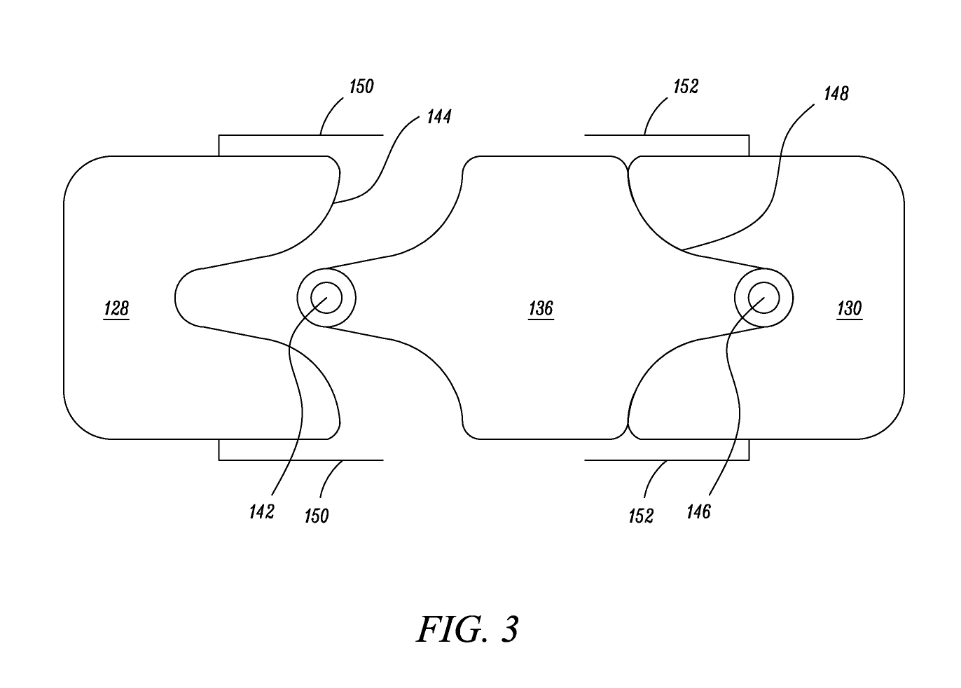

FIG. 3 illustrates an orthogonal view of the latching system 126 in a first operational state. The first release member 138 is actuated from outside of the operator enclosure 106 to disengage the striker 136 from the first latching member 128 such that the door 102 is movable from the hold-open position. When the first release member 138 is actuated, the striker 136 remains coupled with the second latching member 130 after being disengaged from the first latching member 128. The second support portion 152 is configured to retain the striker 136 adjacent to the second latching member 130 if the second release member 140 is actuated after the striker 136 is disengaged from the first latching member 128.

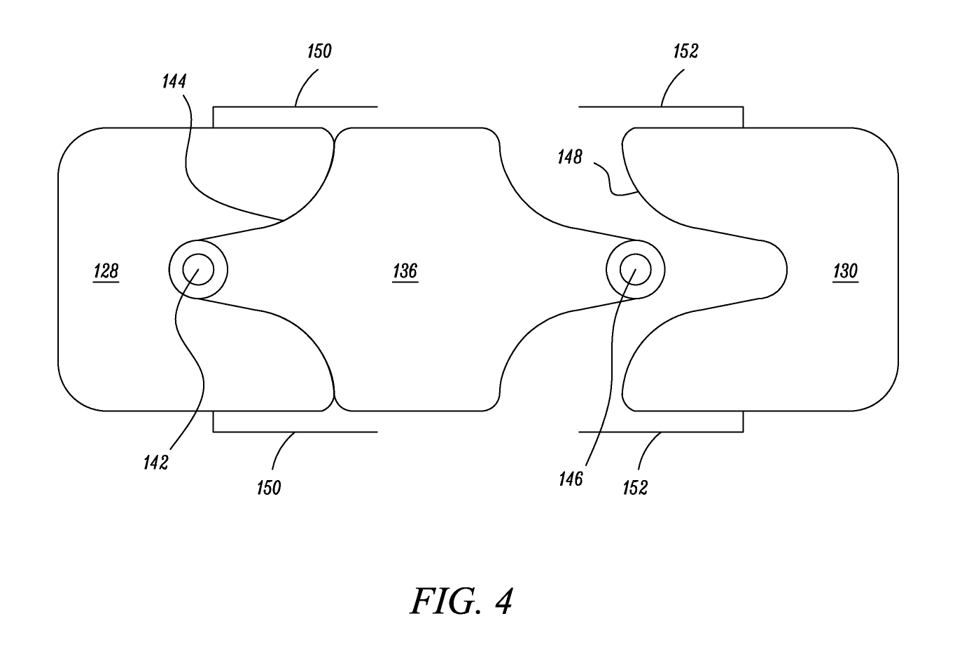

FIG. 4 illustrates an orthogonal view of the latching system 126 in a second operational state. The second release member 140 is actuated from inside of the operator enclosure 106 to disengage the striker 136 from the second latching member 130 such that the door 102 is movable from the hold-open position. When the second release member 140 is actuated, the striker 136 remains coupled with the first latching member 128 after being disengaged from the second latching member 130. The first support portion 150 is configured to retain the striker 136 adjacent to the first latching member 128 if the first release member 138 is actuated after the striker 136 is disengaged from the second latching member 130.

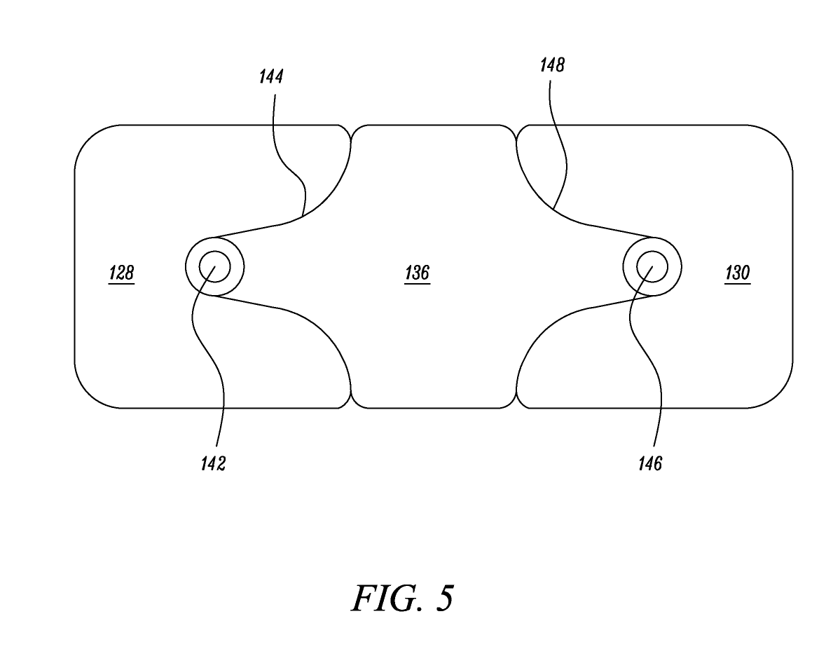

FIG. 5 illustrates an orthogonal view of the latching system 126 associated, according to another embodiment of the present disclosure. In the embodiment of FIG. 5, the first and second latching members 128, 130 may not include any support portions. In an example, the striker 136 may be retained adjacent to the first and second latching members 128, 130 in the second and first operational states, respectively, by a magnetic or electromagnetic field associated with the latching system 126. The magnetic or electromagnetic fields may be active only when the striker 136 is disengaged from one of the first and second latching members 128, 130 such as not to interfere with an engagement and/or disengagement of the striker 136 from the first and second latching members 128, 130.

### Industrial Applicability

Machines include an operator enclosure having a door. A latching mechanism is provided for retaining the door of the operator enclosure in a hold-open position. Multiple release systems may be provided at various locations of the machine to release the latching mechanism. Some of the locations may not be conveniently accessible by an operator. Further, such latching mechanisms may include complicated cables and/or mechanical linkages.

The present disclosure is related to the door system 100 for the door 102 of the machine. The door system 100 includes the latching system 126 configured to retain the door 102 in the hold-open position. The latching system 126 includes the striker 136 having the first interlocking element 142 and the second interlocking element 146 configured to selectively couple with the first latching member 128 and the second latching member 130, respectively.

The door system 100 may enable an operator of the machine to release the door 102 from the hold-open position by actuating either the first release member 138 or the second release member 140. Further, the first release member 138 and the second release member 140 are accessible from inside and outside the operator enclosure 106. Therefore, the operator may be able to conveniently release the door 102 from both inside and outside the operator enclosure 106. Moreover, the first latching member 128 and the second latching member 130 are only coupled by the striker 136 when the door 102 is in the hold-open position. When the door 102 is released from the hold-open position, there is no coupling between the first and second latching members 128, 130. Thus, the first and second latching members 128, 130 along with the respective release member 140, 142 may be separate units with no actuating members (e.g., a mechanical linkage and/or a cable) provided between them. For example, the first latching member 128 and the first release member 140 may be connected by a cable placed along and/or within the door 102. The second latching member 130 and the second release member 142 may be connected by a cable placed inside the operator enclosure 106. Thus, the door system 100 may be convenient to assemble within the door 102 and operator enclosure 106.

Further, the first support portion 150 and the second support portion 152 may retain the striker 136 adjacent to the first and second latching members 128, 130, respectively in case of accidental actuation of the first and second release members 140, 142, respectively when the door is released from the hold-open position.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A door system for a machine, the door system comprising:
a door movable between a closed position and a hold-open position;
a first latching member coupled to the door, the first latching member including a first support portion;
a first release member coupled to the door, the first release member being operably connected to the first latching member, wherein the first release member is actuable from outside an operator enclosure of the machine;
a second latching member coupled to the operator enclosure of the machine, the second latching member including a second support portion;
a second release member coupled to the operator enclosure, the second release member being operably connected to the second latching member, wherein the second release member is actuable from inside the operator enclosure; and
a striker including a first interlocking element configured to selectively couple with the first latching member, and a second interlocking element configured to selectively couple with the second latching member;
wherein the striker is configured to couple with the first latching member and the second latching member to retain the door in the hold-open position;
wherein in response to actuation of the first release member the striker is disengaged from the first latching member such that the door is movable from the hold-open position and the striker remains coupled with the second latching member;
wherein in response to actuation of the second release member the striker is disengaged from the second latching member such that the door is movable from the hold-open position, and the striker remains coupled with the first latching member;
wherein the first support portion is configured to retain the shuttle adjacent to the first latching member when the shuttle is disengaged from the second latching member; and
wherein the second support portion is configured to retain the shuttle adjacent to the second latching member when the shuttle is disengaged from the first latching member.
